(19) United States
(12) Patent Application Publication
(10) Pub. No.: US 2021/0231170 A1
(43) Pub. Date: Jul. 29, 2021

(54) SELF-ADJUSTING BUSHING BEARING WITH MAGNETIC LEVITATION

(71) Applicant: CADventures, Inc., Sycamore, IL (US)

(72) Inventor: Douglas A. Larson, Ann Arbor, MI (US)

(73) Assignee: CADventures, Inc., Sycamore, IL (US)

(21) Appl. No.: 17/010,154

(22) Filed: Sep. 2, 2020

Related U.S. Application Data
(60) Provisional application No. 62/966,844, filed on Jan. 28, 2020.

(51) Int. Cl. F16C 25/04; F16C 17/10; F16C 23/04

(52) U.S. Cl. CPC F16C 25/045; F16C 23/04; F16C 17/10

(57) ABSTRACT

A self-adjusting bushing bearing receivable within a housing to control movement of a shaft therein. Shaft magnet segments are configured to receive the shaft therein, where each shaft magnet segment has an inner portion having an inner polarity and an outer portion of the shaft magnet segments has an outer polarity that is opposite the inner polarity. Bearing magnet segments are configured to receive the shaft magnet segments therein, where each of the bearing magnet segments has an inner portion having an inner polarity and an outer portion of the bearing magnet segments has an outer polarity that is opposite the inner polarity. A springy element is disposed between the housing and the bearing magnet segments to bias the bearing magnet segments radially inwardly relative to the shaft magnet segments. The outer polarity of the shaft magnet segments is the same as the inner polarity of the bearing magnet segments so as to repel each other.

### CROSS-REFERENCE TO RELATED APPLICATION

This application claims the benefit of and priority to U.S. Provisional Patent Application No. 62/966,844, filed Jan. 28, 2020, which is hereby incorporated by reference in entirety.

### FIELD

The present disclosure relates to bushing bearings, and more specifically self-adjusting bushing bearings with magnetic levitation.

### BACKGROUND

The following U.S. patents are hereby incorporated herein by reference, in entirety.

U.S. Pat. No. 8,870,459 discloses a self-adjusting bushing bearing for engagement with a shaft. A bearing housing is provided. A bearing sub-assembly is received inside of the bearing housing and the bearing sub-assembly is adapted to receive the shaft. The bearing sub-assembly has at least two bearing segments and at least one springy element engaged with the bearing housing which compresses the bearing segments toward one another.

U.S. Pat. No. 9,790,988 discloses a self-adjusting bushing bearings having a springy element. The self-adjusting bushing bearing has a bearing subassembly that is configured to be received in a housing and also has a plurality of bearing segments that together are configured to receive a shaft therein. A springy element biases the plurality of bearing segments radially inwardly towards the shaft. The springy element is mated with at least one bearing segment in the plurality of bearing segments.

U.S. Pat. No. 9,995,342 discloses a self-adjusting bushing bearing with a shaft seal for engaging a shaft. The self-adjusting bushing bearing has a plurality of bearing segments configured to receive a shaft therein. A springy element engages an outer surface of the plurality of bearing segments and biases the plurality of bearing segments towards the shaft. A shaft seal coupled to the springy element is configured to contact the shaft when the shaft is received in the plurality of bearing segments so as to create an operable seal between the shaft and the housing.

### SUMMARY

This Summary is provided herein to introduce a selection of concepts that are further described herein below in the Detailed Description. This Summary is not intended to identify key or essential features from the claimed subject matter, nor is it intended to be used as an aid in limiting the scope of the claimed subject matter.

The present disclosure generally relates to a self-adjusting bushing bearing that is receivable within a housing and configured to control movement of a shaft therein. Shaft magnet segments are configured to receive the shaft therein, where each of the shaft magnet segments has an inner portion having an inner polarity and an outer portion of the shaft magnet segments has an outer polarity that is opposite the inner polarity. Bearing magnet segments are configured to receive the shaft magnet segments therein, where each of the bearing magnet segments has an inner portion having an inner polarity and an outer portion of the bearing magnet segments has an outer polarity that is opposite the inner polarity. A springy element is disposed between the housing and the bearing magnet segments to bias the bearing magnet segments radially inwardly relative to the shaft magnet segments. The outer polarity of the shaft magnet segments is the same as the inner polarity of the bearing magnet segments so as to repel each other.

Another embodiment of the present disclosure generally relates to a self-adjusting bushing bearing that is receivable within a housing and configured to control movement of a shaft therein. Shaft magnet segments are configured to receive the shaft therein, where each of the shaft magnet segments has an inner portion having an inner polarity and an outer portion of the shaft magnet segments has an outer polarity that is opposite the inner polarity. Bearing magnet segments are configured to receive the shaft magnet segments therein, where each of the bearing magnet segments has an inner portion having an inner polarity and an outer portion of the bearing magnet segments has an outer polarity that is opposite the inner polarity. A springy element is disposed between the housing and the shaft to bias the shaft radially inwardly relative to the housing. The outer polarity of the shaft magnet segments is the same as the inner polarity of the bearing magnet segments so as to repel each other.

Another embodiment of the present disclosure generally relates to a self-adjusting bushing bearing that is receivable within a housing and configured to control movement of a shaft therein. Shaft magnet segments are configured to receive the shaft therein, where each of the shaft magnet segments has an inner portion having an inner polarity and an outer portion of the shaft magnet segments has an outer polarity that is opposite the inner polarity. Bearing magnet segments are configured to receive the shaft magnet segments therein, where each of the bearing magnet segments has an inner portion having an inner polarity and an outer portion of the shaft magnet segments has an outer polarity that is opposite the inner polarity, where the outer polarity of the shaft magnet segments is the same as the inner polarity of the bearing magnet segments so as to repel each other. A springy element is disposed between the shaft and the shaft magnet segments to bias the shaft magnet segments radially outwardly away from the shaft. A magnetic thrust washer receives the shaft therein and is axially displaced from the bearing magnet segments, where the magnetic thrust washer has an inner portion having an inner polarity and an outer portion of the shaft magnet segments has an outer polarity that is opposite the inner polarity, and where the magnetic thrust washer is positioned such that the inner portion of the magnetic thrust washer repels both the inner portions of the bearing magnet segments and the outer portions of the shaft magnet segments. The bearing magnet segments are rotationally fixed relative to the housing.

Another embodiment of the present disclosure generally relates to a self-adjusting bushing bearing that is receivable within a housing and configured to control movement of a shaft therein. Shaft magnet segments are configured to receive the shaft therein, where each of the shaft magnet segments has an inner portion having an inner polarity and an outer portion of the shaft magnet segments has an outer polarity that is opposite the inner polarity. Bearing magnet segments are configured to receive the shaft magnet segments therein, where each of the bearing magnet segments has an inner portion having an inner polarity and an outer portion of the shaft magnet segments has an outer polarity that is opposite the inner polarity, where the outer polarity of the shaft magnet segments is the same as the inner polarity of the bearing magnet segments so as to repel each other. A first springy element is disposed between the housing and the bearing magnet segments to bias the bearing segments inwardly towards the shaft. A second springy element is disposed between the shaft and the shaft magnet segments to bias the shaft magnet segments radially outwardly away from the shaft. The outer polarity of the shaft magnet segments is the same as the inner polarity of the bearing magnet segments so as to repel each other.

Various other features, objects and advantages of the disclosure will be made apparent from the following description taken together with the drawings.

### BRIEF DESCRIPTION OF DRAWINGS

The present disclosure is described with reference to the following figures.

FIG. 1 is a front schematic view of an exemplary Self-Adjusting Bushing Bearing (SABB) with incorporating magnetic levitation according to the present disclosure.

FIG. 2 is a graph demonstrating the relationship between gap ratios and force ratios for SABBs incorporating springy elements, magnetic levitation, and both as provided by the present disclosure.

FIG. 3 is an isometric view of one embodiment of SABB incorporating magnetic levitation according to the present disclosure.

FIG. 4 depicts the SABB of FIG. 3 with the housing partially removed.

FIG. 5 is an exploded view of the SABB of FIG. 3 with the housing removed.

FIG. 6 is a sectional isometric side view taken along the line 6-6 in FIG. 3.

FIG. 7 is a sectional front view taken along the line 7-7 in FIG. 3.

FIG. 8 is a sectional side view similar to that of FIG. 6 of another embodiment of SABB incorporating magnetic levitation according to the present disclosure.

FIG. 9 is a sectional front view taken along the line 9-9 in FIG. 8.

FIG. 10 is a sectional side view similar to that of FIG. 6 of another embodiment of SABB incorporating magnetic levitation according to the present disclosure.

FIG. 11 is a sectional front view taken along the line 11-11 in FIG. 10.

### DETAILED DESCRIPTION OF THE DRAWINGS

Self-Adjusting Bushing Bearings (SABBs) are generally known in the art, exemplified by the devices disclosed in U.S. Pat. No. 8,870,459. SABBs are generally known to comprise at least two bearing segments configured to receive a shaft, also having at least one springy element that engages the outside surfaces of the bearing segments to compress the bearing segments toward one another in an inward direction. This springy element also contacts the inside surface of a housing when the SABB is received within the housing. In this regard, the springy elements bias the bearing segments into contact with the shaft when a shaft is received inside the SABB, maintaining this contact despite wear of the elements. This use of springy elements generally allows the machining tolerances of the shaft and housing containing the SABB to not be near as tight as required for standard bushing, ball, and roller bearings. Furthermore, the springy elements allow the same SABB to accommodate both conical and cylindrical shafts.

Through research and experimentation, the present inventor has identified further opportunities for improving upon SABBs known in the art, specifically through the use of magnetic levitation. The use of magnetic force in bearings to keep the rotating parts from contacting each other has many advantages, including having: 1) essentially no friction; 2) no wear of mating parts; 3) no “stiction” as an increased friction (and wear) at start-up until the contact surfaces are fully lubricated; 4) no failures due to loss of lubricant; 5) no failures due to degradation of the lubricant over time; 5) no failures due to contamination of the lubricant, and 6) essentially no change in friction due to changes in temperature, to name a few.

However, magnetic bearing systems known in the art are very expensive because in addition to the use of permanent magnets to provide a separating force between the shaft and housing, additional electromagnets and associated control circuits are needed to maintain the stability of the assembly due to the Earnshaw Theorem. Earnshaw's Theorem states that a collection of point charges cannot be maintained in a stable stationary equilibrium configuration solely by the electrostatic interaction of the charges. This was first mathematically demonstrated by British mathematician Samuel Earnshaw in 1842. It is usually referenced to magnetic fields, but was first applied to electrostatic fields.

The instability is because the strength of a magnetic field falls off as the inverse-square of the distance. For example, the force of the same magnet with a given gap g is ¼th as strong when the gap is doubled to 2 g. Earnshaw showed that this non-linear force vs. distance characteristic is unstable if, for example, you try to use a bushing bearing made out of a permanent magnet material in which the inside surface of the bushing bearing has the same magnetic polarity as the outside surface of the shaft.

The Earnshaw Theorem is based solely upon electrostatic/magnetic forces. However, the Self-Adjusting Bushing Bearing (SABB) described in U.S. Pat. Nos. 8,870,459, 9,790,988, and 9,995,342 are based on the addition of a resilient or a “springy element” that can be designed to complement the magnetic force such that the combined spring force and magnetic repulsion force vs. radial displacement provides dynamic stability. In other words, the inventor has recognized that the “springy element” feature U.S. Pat. Nos. 8,870,459, 9,790,988, and 9,995,342 can be used to provide the resilience necessary to stabilize an SABB with magnetic levitation using repelling permanent magnet bearing surfaces.

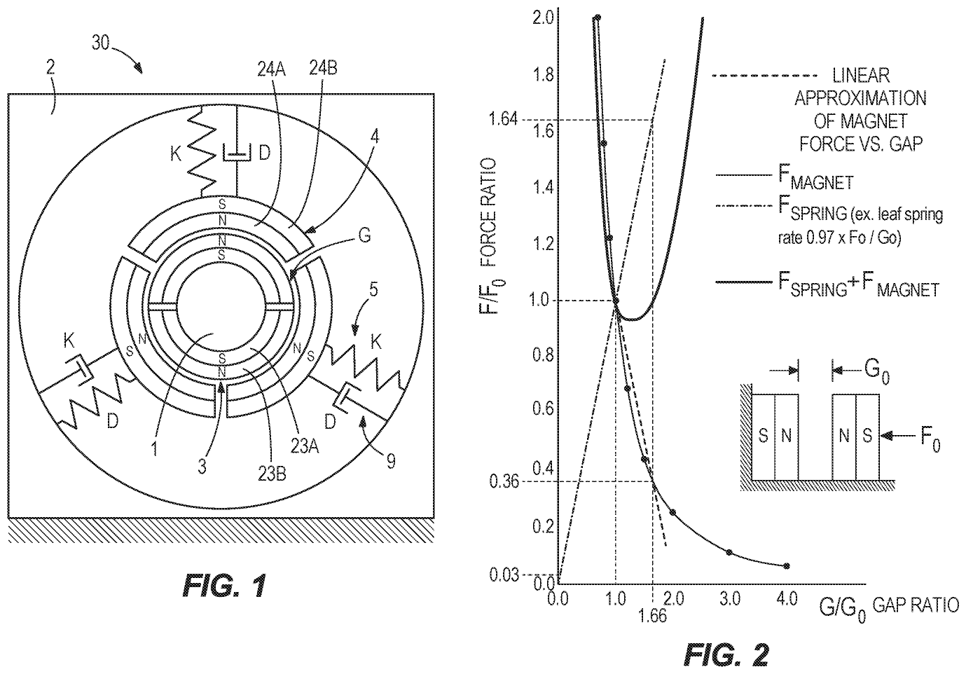

FIG. 1 is a schematic representation of an SABB 30 incorporating magnetic levitation according to the present disclosure. Additional information regarding SABBs in general is provided in U.S. Pat. Nos. 8,870,459, 9,790,988, and 9,995,342. The figure shows an SABB 30 in which one or more shaft magnet segments 3 are coupled or integrally formed with the shaft 1 to rotate therewith. The shaft magnet segments 3 are radially magnetically polarized permanent magnets with the “N” or North magnetic polarity on the outer diameter or outer portion 23B and the “S” or South magnetic polarity on the inner diameter or inner portion 23A having the interior of the shaft 1 (in the present case, next to the shaft 1). It will be recognized that the polarities of the outer portion 23B and inner portion 23A may also be reversed, for example. FIG. 1 further shows three bearing segments 4 that together encircle the shaft magnet segments 3. However, unlike bearing segments known the art, the present SABB 30 includes bearing magnet segments 4 that are magnetized. Specifically, the bearing magnet segments 4 are magnetized in an opposite manner as the shaft magnet segments 3, whereby the outer diameters or outer portions 24B of the bearing magnet segments 4 have an “S” or South magnetic polarity and the opposite inner diameters or inner portions 24A have a “N” or north magnetic polarity (or the opposite where the shaft magnet segments 3 are oppositely configured).

The result of this configuration is that the bearing magnet segments 4 are magnetically repelled away from the shaft magnet segments 3 by virtue of the same magnetic polarities facing one another. This in turn causes magnetic levitation of the bearing magnet segments 4 relative to the shaft magnet segments 3, and likewise relative to the shaft 1 contained within the housing 2.

FIG. 1 further shows that the bearing magnet segments 4 being radially mechanically constrained by a spring or other biasing member (also referred to herein as a springy element 5) having a spring constant (K), and a damper 9 with a damping coefficient (D). In certain embodiments, the springy element 5 is a leaf spring and the damper is an O-ring. However, in other embodiments O-rings may be used to provide both the spring force and damping, for example. The present inventor has recognized that by incorporating a springy element 5 and/or damper 9 along with the magnetic repulsion forces between the shaft magnet segments 3 and the bearing magnet segments 4, the combined force is stable notwithstanding different deflection distances of the shaft 1. Therefore, the presently disclosed systems and methods overcome the Earnshaw Theory's instability of magnetic force when attempting to use magnetic repulsion force alone in a bearing configuration. FIG. 1 also shows that the circumferential magnetic repulsion forces will maintain equal spacing between the shaft 1 and bearing magnet segments 4.

FIG. 2 shows a graph of the relationship between changes in the ratios of force F/F0 versus change in the ratios of gap G/G0 for a Permanent Magnet SABB in which the springy element 5 is, for example, a leaf spring. G0 is the initial gap G (FIG. 1) between the bearing magnet segments 4 and shaft magnet segments 3, and F0 is the initial magnetic repulsion force when the Gap G=G0. The graph of FIG. 2 shows how the repulsion force ratio Fm/F0 of the magnets (i.e., the repulsion between the bearing magnet segments 4 and shaft magnet segments 3) falls off as the inverse square of the change in gap ratio G/G0. FIG. 2 further shows that the magnetic force ratio Fm/F0 is approximately linear from G/G0=1 to G/G0=1.66. Therefore, the present inventor has identified that a springy element 5 could be designed with an Fs/F0 versus G/G0 relationship that mirrors the Fm/F0 vs. G/G0 of the magnets such that the combined force counteracts against perturbations of the shaft 1 and therefore dynamically stable as shown by the “U” shape (labeled F_{Spring}+F_{Magnet}), for example.

Additionally, the present inventor has recognized that if the springy element 5 is an O-ring or X-ring, by itself or in combination with a leaf spring, it will also provide vibration damping (D), as depicted in FIG. 1. Furthermore, for gaps less that G/G0=1.0, the bearing magnet segments 4 are stabilized more and more by the magnetic repulsion force Fm as G/G0 approaches 0. Since the magnetic force Fm versus gap G is essentially linear in this region, and is still being aided by the spring force K, the system is dynamically stable. For gap G change greater than G/G0=1.66, the bearing magnet segments 4 are stabilized more and more by the spring force K as the magnetic force Fm falls off as the inverse square of the change in gap G. Furthermore, since the combined spring force FSpring and magnet force FMagnet opposite any shaft 1 radial motion, the system is dynamically stable.

The slope (SMagnet) of the magnetic forces Fm within the linear approximation region of the Magnet Force Fm versus gap G from G/G0=1 to G/G0=1.66 is approximated as follows:

$$\begin{matrix}SMagnet = Δ ( FMagnet / F0 ) / Δ ( G / G0 ) \\ = ( 0.36 - 1.00 ) / ( 1.66 - 1.00 ) \\ = - 0.64 / .66 \\ = - 0.97\end{matrix} \qquad Eqn . 1 )$$

The Slope (SSpring) of the Spring Force Fm versus gap G is the mirror image of the slope of the Magnet Force Fm vs gap G:

SSpring=0.97 Eqn. 2)

SSpring=Δ(FSpring/F0)/Δ(G/G0)=0.97 Eqn. 3)

Solving Eqn. 3) for ΔFSpring/ΔG:

ΔFSpring/ΔG=0.97(F0/G0)=KSpring Eqn. 4)

KSpring=0.97(F0/G0) Eqn. 5)

By way of example:

$$\begin{matrix}F0 = 10 Lbs . \\ G0 = 0.010 in . \\ KSpring = 0.97 ( F0 / G0 ) \\ = 0.97 ( 10 / 0.010 ) \\ = 970 Lbs / in\end{matrix}$$

The result demonstrated above shows that dynamic stability for a permanent magnet repulsion force of 10 lbs at a gap of 0.010″ can be achieved with a springy element having a spring rate (K) of 970 Lbs/in and an installed opposing force of 10 lbs. The above KSpring and loads are for illustrative purpose and do not mean that other KSpring and loads would not also result in dynamic stability. A major function of the disclosed device is that the decrease in the magnetic repulsion force as the gap G increases will be compensated by the increase in springy element 5 force such that the combined force will oppose any radial motion of the shaft 1, thereby creating a dynamic and stable response to a perturbation.

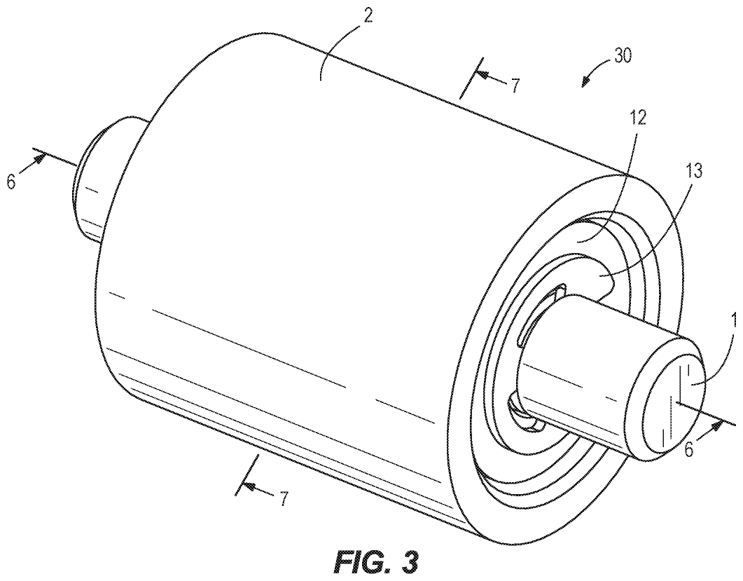

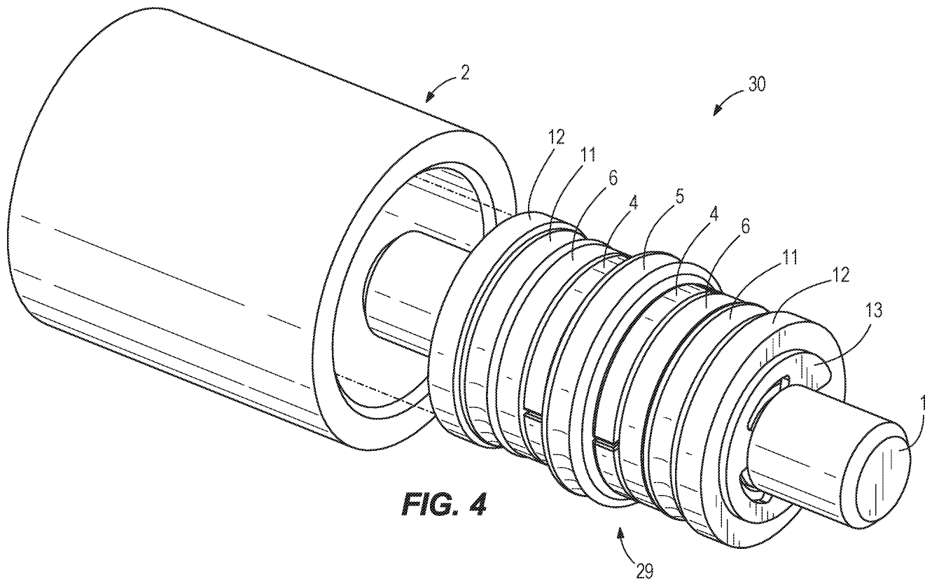

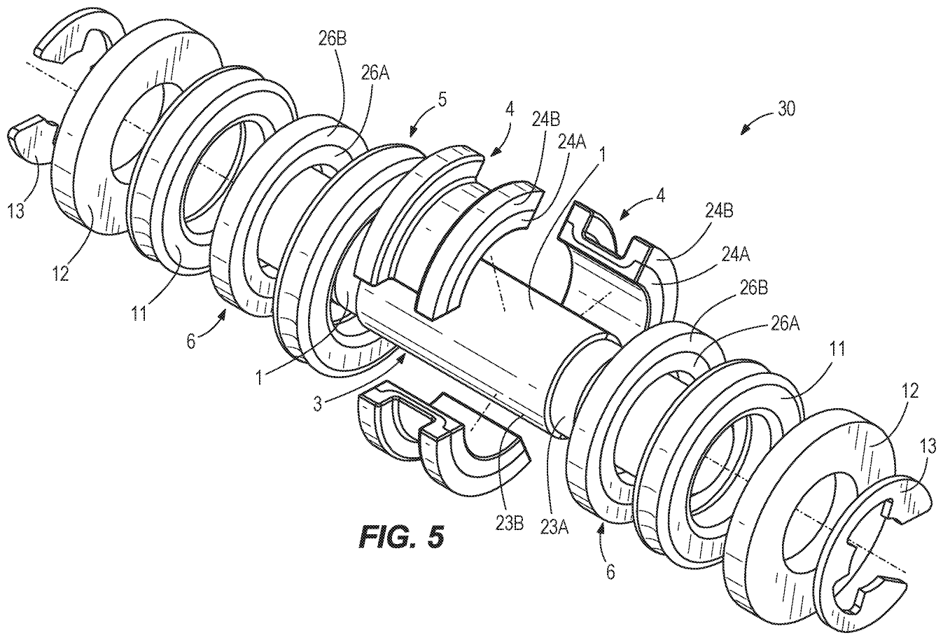

FIGS. 3-7 depict different views of a first embodiment of an SABB 30 with permanent magnet levitation according to the present disclosure. FIGS. 3-5 show the SABB 30 as an internal assembly 29 formed of the shaft magnet segments 3 and bearing magnet segments 4 being radially retained on the shaft 1 by a springy element 5, whereby the internal assembly 29 is then inserted into the housing 2 to form the entire SABB 30 system. Additional components that may be considered as the internal assembly 29 include magnet thrust washers 6 that create additional opposing magnet forces acting on the shaft magnet segments 3 and/or bearing magnet segments 4 (discussed further below), as well as a thrust springy element 11 for biasing the magnet thrust washers 6 towards the bearing magnet segments 4, and retainers 12 for retaining the thrust springy elements 11 in position relative to the shaft 1, for example using a snap ring 13 engaged therewith. In certain embodiments, certain components shown as being within the internal assembly 29 in FIG. 2 may instead be integrally formed or coupled to the housing 2 such that they these components are not removable therefrom in practice, which is discussed further below. For example, the bearing magnet segments 4 may be integrally formed with or otherwise fixed within the housing 2.

As discussed above, the embodiment of FIGS. 4-7 includes a springy element 5 that encircles the bearing magnet segments 4 and are coaxially aligned with the shaft 1 in a manner similar to that discussed in U.S. Pat. Nos. 8,870,459, 9,790,988, and 9,995,342. Additionally, thrust springy elements 11 are provided that are also coaxial with the shaft 1, but axially displaced from the bearing magnet segments 4. In the example shown, both the springy element 5 and the thrust springy elements 11 are shown as X-rings; however, other types of springy elements are also anticipated by the present disclosure, which would be in place of and/or in addition to the X-rings shown.

The figures further show an embodiment in which two shaft magnet segments 3 are wrapped around the shaft 1; however, other numbers of shaft magnet segments 3 are also anticipated by the present disclosure. The shaft magnet segments 3 are radially magnetized such that an inner portion 23A having a first polarization (e.g., South) next to the shaft 1, and an opposing outer portion 23B having a second polarization that is opposite the first polarization (North in this example). Three bearing magnet segments 4 that are concentric with the two shaft magnet segments 3. The bearing magnet segments 4 are radially magnetized so as to define an inner portion 24A having a first polarity (in this example, North) at its inner diameter, in other words, facing radially inwardly towards the shaft magnet segments 3 and shaft 1. Likewise, an outer portion 24B of the bearing magnet segments 4 has an opposite second polarity, which in this example would necessarily be South. In this manner, the outer portions 23B of the shaft magnet segments 3 are adjacent to the inner portion 24A of the bearing magnet segments 4, which has the same polarity and thus oppose each other.

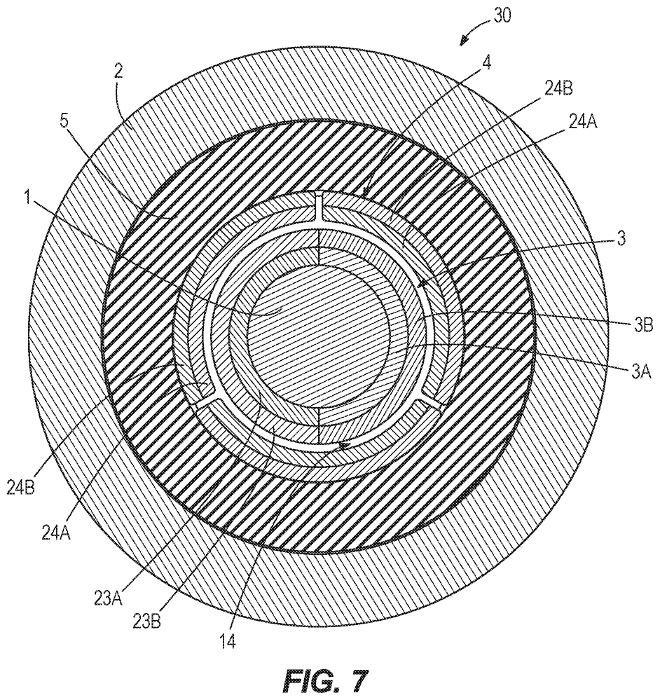

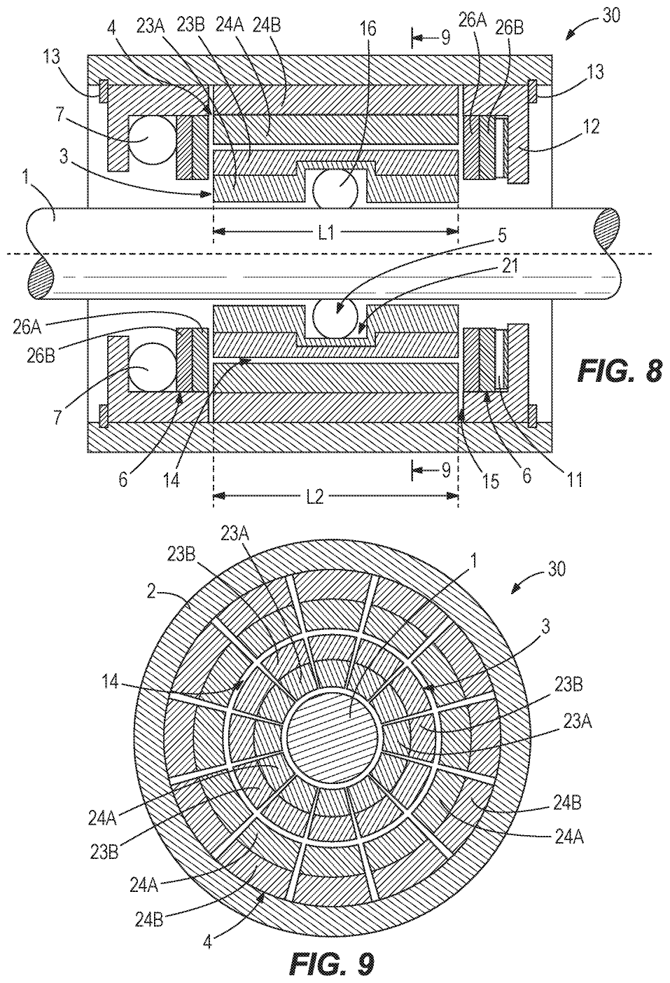

A springy element 5 is disposed between the bearing magnet segments 4 to the inside diameter of the housing 2, which in certain examples prevents rotational movement therebetween. As best shown in FIGS. 7 and 8, a circumferential gap 14 is created and maintained by the magnetic repulsion force between the shaft magnet segments 3 and the bearing magnet segments 4. Therefore, the magnetic repulsion force generally opposes the biasing forces created by the springy element 5 in the present configuration such that the shaft 1 levitates in the center. It will be recognized that while the springy element 5 is depicted as an X-ring or other elastomeric material, the springy element 5 may alternatively or additionally be another biasing device such as a leaf spring or linear coiled spring, for example. In certain examples, the multiple types of springy elements 5 would all provide biasing forces in the same radial direction.

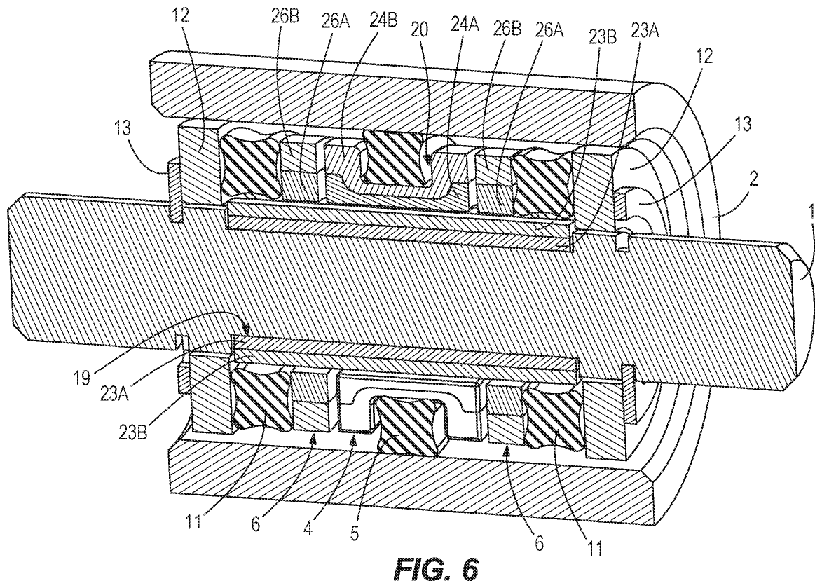

FIG. 6 further shows the incorporation of magnetic thrust washers 6 located at each end of the shaft magnet segments 3 and bearing magnet segments 4. The magnetic thrust washers 6 also have an inner portion 26A having a first polarity and an opposite outer portion 26B having a second polarity that is opposite the first polarity. As will become apparent, in certain embodiments the inner portion 26A is radially apart from the outer portion 26B (e.g., FIG. 6), whereas in other embodiments the inner portion 26A is axially apart from the outer portion 26B (e.g., FIG. 8). In the embodiment of FIG. 6, the magnetic thrust washers 6 are oriented such that the inner portion 26A (for example, having a North polarity) is next to the outer portions 23B of the shaft magnet segments 3 and the inner portions 24A of the bearing magnet segments 4 (both also having a North polarity) such that there is a repulsion force between them. Likewise, the outer portion 26B of the magnetic thrust washer 6 is adjacent to the outer portions 24B of the bearing magnet segments 4, which in the present example would have a South polarity.

The magnetic thrust washers 6 are resiliently loaded against the bearing magnet segment 4, for example by a thrust springy element 11, such as an X-ring, for example. Both the magnetic thrust washer 6 and thrust springy element 11 are supported by a thrust retainer 12 that is axially located on the shaft 1 by snap ring 13. It will be recognized that the relative positions of these elements may also be modified, including relative to the housing 2, for example. It will also be recognized that FIG. 6 also shows an embodiment in which the shaft magnet segments 3 are received within a recess 19 defined within the exterior surface of the shaft 1. In the example shown, a similar recess 20 is also defined within the exterior surface of the bearing magnet segments 4 for receiving the springy element 5, for example. While the recesses 19, 20 assist with locating and retaining the shaft magnet segments 3 and springy element 5, respectively, these are not required features to practice the invention and either may not be present in other embodiments.

FIGS. 8-9 depict an alternate embodiment in which the springy element 5 is positioned between the shaft 1 and the shaft magnet segments 3. In certain embodiments, the bearing magnet segments 4 are further prevented from rotating relative to the housing 2 in a manner known in the art (including but not limited to via friction alone). Additionally, as best shown in FIG. 9, the present embodiment incorporates an equal number of shaft magnet segments 3 and bearing magnet segments 4, which in the present case twelve equally spaced pairs. However, any number of pairs (or differing numbers of shaft magnet segments 3 versus bearing magnet segments 4) are also anticipated by the present disclosure. Because the bearing magnet segments 4 and shaft magnet segments are each provided as 12 wedges, each can be simply linearly magnetized and collectively will approximate radially magnetized magnets. The magnet wedges will automatically space themselves circumferentially as a result of the magnetic repulsion. Furthermore, if the shaft 1 and housing 2 are made of magnetic metal, the magnetic attraction will help in the assembly.

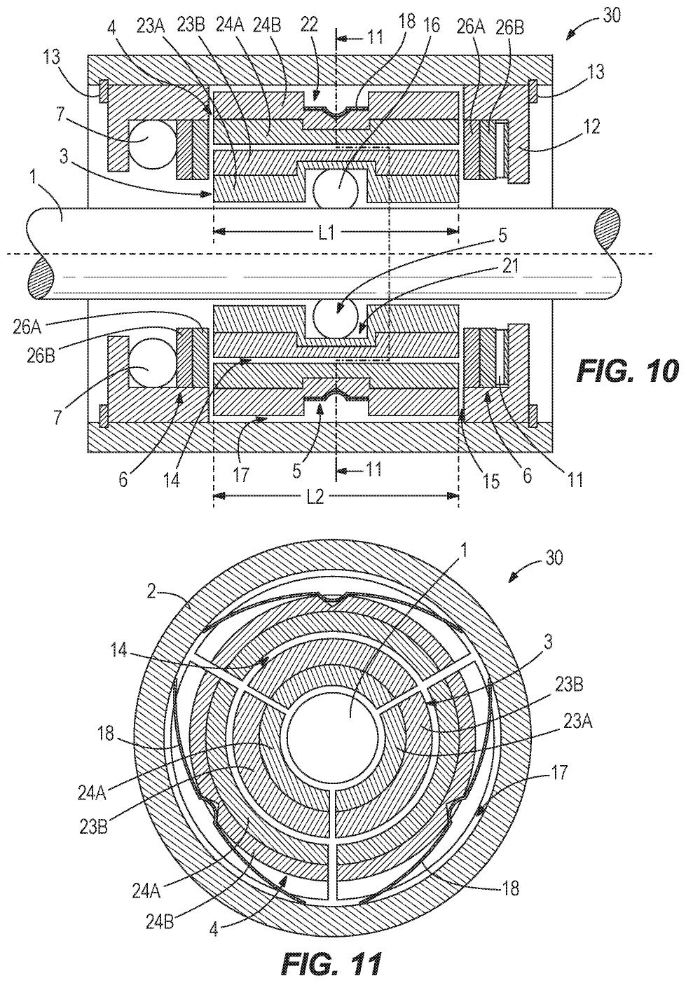

Yet another exemplary embodiment is provided in FIGS. 10-11, which depicts the incorporation of two different springy elements 5, specifically those providing biasing forces in different directions (in the present example, opposing directions). The springy elements 5 include first springy elements 16 presently shown as an o-ring and positioned between the shaft 1 and the shaft magnet segments 3, as well as second springy elements 18 presently shown as a leaf spring and positioned between the housing 2 and the bearing magnet segments 4. In the example shown, the first springy elements 16 are retained within a channel 21 defined within the shaft magnet segments 3, and the second springy elements 18 are retained within a channel 22 defined within the bearing magnet segments 4.

Both the second springy element 18 and the first springy element 16 provide resiliency for angular and radial misalignment, shock, and any differences due to differences in coefficients of thermal expansion. In this embodiment, the second springy element 18 provides the necessary preload to stabilize the permanent magnet repulsion forces while the first springy element 16 dampens vibrations.

The second springy elements 18 (or leaf springs used as any of the springy elements 5) can be fabricated to produce any desired force vs. deflection characteristics by changing the thickness, width, length, and/or material. The leaf springs can also be stacked on top of one another. Furthermore, if the leaves are triangular shaped they will deflect semi-circularly and will be uniformly stressed.

FIG. 10 further shows an embodiment in which the length L1 of the shaft magnet segments 3 is substantially equal to the length L2 of the bearing magnet segments 4 in the axial direction. However, it will be recognized that these lengths L1, L2 need not be the same, and in certain embodiments are preferably different, such as that shown in FIG. 6. FIG. 10 also best shows a gap 17 formed between the housing 2 and the bearing shaft segments 4 by virtue of the springy element 5, similar to SABBs presently known in the art.

While the embodiments shown generally relate to that of a rotational bearing, the invention can also be used as a linear bearing. For example, the bearing magnet segments 4 could be made with an axial dimension equal to the desired linear travel and secured by the snap rings and thrust washer assemblies that act as a cushion at the end of the travel each way. The shaft magnet segments 3, springy elements 5, and shaft 1 would then be able to translate relative to the bearing segment magnets 4 and vice versa.

A distinction between the SABB 30 presently disclosed and those known in the art is the magnetic levitation provided by the incorporation of permanent magnets. As shown in FIG. 1, one method of fabrication is to provide two magnet segments for the shaft magnet segments 3 and three magnet segments for the bearing magnet segments 4. The shaft 1 can be made of magnetic or non-magnetic material because the essentially frictionless nature of the SABB magnet gap 14 will guarantee that shaft magnet segments 3 will not spin with respect to the shaft 1. The two-segment and three-segment permanent magnets should be radially magnetized as shown. The magnetic thrust washers 6 are linearly magnetized across the faces as shown. Wave washers, O-rings, coil springs, wave springs, and/or the like can be used as the springy elements 7, 11 for the thrust washer magnets. For example, FIG. 8 shows that a springy element on one end may act as a wave washer 11 or other wave spring by providing a given preload to work against and stabilize the magnetic repulsion forces, while using the springy element 7 on the other end to absorb vibrations.

In certain embodiments, magnetic thrust washers 6 are positioned at each end of the SABB 30 and are positioned along the axis of the housing 2 by means of snap rings 13 that engage to retain the retainer 12 in position relative to the shaft 1. As shown in FIGS. 8 and 10, the magnetic thrust washers 6 in practice create a gap 15 between the shaft magnet segments 3 (and/or the bearing magnet segments 4) and the magnetic thrust washer 6 (as well as the retainer 12, for example).

The figures show various embodiments for the discussion below. Various other configurations can be assembled based on the same principle but utilizing different components. For example, the figures show the use of an O-rings or leaf springs, but other components individually or in combination can be used such as X-rings and coil springs. Furthermore, since the embodiment is based on the SABB patents incorporated by reference herein, all the features described in the patents can be added such as shaft seals and lubricants. Additionally, because of the magnetism of the permanent magnets, a lubricant could be used that contains stable suspensions of magnetic material to help ensure that the lubricant remains in contact with the magnet surfaces and does not leak out without seals or with seals that fail. Finally, since magnetic strength of a permanent magnet or paramagnetic material can be increased by bringing other magnets in series with it, the magnetic SABB load carrying capacity can be enhanced by the addition of other permanent magnets or electromagnets without the necessary electronic control systems used in conventional electromagnetic bearings.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A self-adjusting bushing bearing that is receivable within a housing and configured to control movement of a shaft therein, comprising:
shaft magnet segments configured to receive the shaft therein, wherein each of the shaft magnet segments has an inner portion having an inner polarity and an outer portion of the shaft magnet segments has an outer polarity that is opposite the inner polarity; and
bearing magnet segments configured to receive the shaft magnet segments therein, wherein each of the bearing magnet segments has an inner portion having an inner polarity and an outer portion of the bearing magnet segments has an outer polarity that is opposite the inner polarity; and
a springy element disposed between the housing and the shaft to bias the shaft radially inwardly relative to the housing;
wherein the outer polarity of the shaft magnet segments is the same as the inner polarity of the bearing magnet segments so as to repel each other.

2. The SABB according to claim 1, wherein the springy element is disposed between the housing and the bearing magnet segments.

3. The SABB according to claim 1, wherein the springy element is disposed between the shaft and the shaft magnet segments.

4. The SABB according to claim 1, wherein the springy element comprises inner and outer springy elements, wherein the inner springy elements are disposed between the shaft magnet segments and the shaft and the outer springy elements are disposed between the housing and the bearing magnet segments.

5. The SABB according to claim 1, wherein the outer portions of the shaft magnet segments and the bearing magnet segments are radially farther than the inner portions of the shaft magnet segments and the bearing magnet segments, respectively, from the shaft.

6. The SABB according to claim 1, further comprising a magnetic thrust washer that receives the shaft therein and is axially displaced from the bearing magnet segments, wherein the magnetic thrust washer has an inner portion having an inner polarity and an outer portion of the shaft magnet segments has an outer polarity that is opposite the inner polarity, and wherein the magnetic thrust washer is positioned so as to repel the bearing magnet segments.

7. The SABB according to claim 6, wherein the magnetic thrust washer is positioned so as to axially repel the bearing magnet segments.

8. The SABB according to claim 6, wherein the magnetic thrust washer is positioned so as to radially repel the shaft magnet segments.

9. The SABB according to claim 6, wherein the outer portion of the magnetic thrust washer is radially farther than the inner portion from the shaft.

10. The SABB according to claim 6, further comprising a thrust springy element that biases the magnetic thrust washer axially towards the bearing magnet segments.

11. The SABB according to claim 6, wherein the shaft defines a channel, and wherein the shaft magnet segments are received at least partially within the channel.

12. The SABB according to claim 1, wherein each of the bearing magnet segments has a first length, and each of the shaft magnet segments is a second length that is greater than the first length.

13. The SABB according to claim 1, wherein the shaft magnet segments are rotationally fixed relative to the shaft.

14. The SABB according to claim 1, wherein the springy element is a first springy element, further comprising a second springy element disposed between the shaft magnet segments and the shaft, wherein the first springy element biases the bearing magnet segments inwardly away from the housing to thereby bias the shaft radially inwardly relative to the housing via repelling between the outer portions of the shaft magnet segments and the inner portions of the bearing magnet segments.

15. The SABB according to claim 14, wherein the first springy element is a leaf spring and the second springy element is an o-ring.

16. The SABB according to claim 1, wherein there are more bearing magnet segments than shaft magnet segments.

17. The SABB according to claim 1, wherein there is a same number of the bearing magnet segments as the shaft magnet segments, and wherein the same number is greater than three.

18. The SABB according to claim 1, wherein the housing is defined as having a front and a back that is opposite the front, and wherein the shaft extends entirely through both the front and the back of the housing.

19. A self-adjusting bushing bearing that is receivable within a housing and configured to control movement of a shaft therein, comprising:
shaft magnet segments configured to receive the shaft therein, wherein each of the shaft magnet segments has an inner portion having an inner polarity and an outer portion of the shaft magnet segments has an outer polarity that is opposite the inner polarity; and
bearing magnet segments configured to receive the shaft magnet segments therein, wherein each of the bearing magnet segments has an inner portion having an inner polarity and an outer portion of the bearing magnet segments has an outer polarity that is opposite the inner polarity, wherein the outer polarity of the shaft magnet segments is the same as the inner polarity of the bearing magnet segments so as to repel each other;
a springy element disposed between the shaft and the shaft magnet segments to bias the shaft magnet segments radially outwardly away from the shaft; and
a magnetic thrust washer that receives the shaft therein and is axially displaced from the bearing magnet segments, wherein the magnetic thrust washer has an inner portion having an inner polarity and an outer portion of the shaft magnet segments has an outer polarity that is opposite the inner polarity, and wherein the magnetic thrust washer is positioned such that the inner portion of the magnetic thrust washer repels both the inner portions of the bearing magnet segments and the outer portions of the shaft magnet segments; and
wherein the bearing magnet segments are rotationally fixed relative to the housing.

20. A self-adjusting bushing bearing that is receivable within a housing and configured to control movement of a shaft therein, comprising:
shaft magnet segments configured to receive the shaft therein, wherein each of the shaft magnet segments has an inner portion having an inner polarity and an outer portion of the shaft magnet segments has an outer polarity that is opposite the inner polarity; and
bearing magnet segments configured to receive the shaft magnet segments therein, wherein each of the bearing magnet segments has an inner portion having an inner polarity and an outer portion of the bearing magnet segments has an outer polarity that is opposite the inner polarity, wherein the outer polarity of the shaft magnet segments is the same as the inner polarity of the bearing magnet segments so as to repel each other;
a first springy element disposed between the housing and the bearing magnet segments to bias the bearing segments inwardly towards the shaft; and
a second springy element disposed between the shaft and the shaft magnet segments to bias the shaft magnet segments radially outwardly away from the shaft;
wherein the outer polarity of the shaft magnet segments is the same as the inner polarity of the bearing magnet segments so as to repel each other.
